(19) United States
(12) Patent Application Publication
(10) Pub. No.: US 2016/0215143 A1
(43) Pub. Date: Jul. 28, 2016

(54) RESIN COMPOSITION, MOLDED BODY, AND PRODUCTION METHOD

(71) Applicant: HITACHI CHEMICAL COMPANY, LTD., Tokyo (JP)

(72) Inventors: Akihito GOTOU, Tsukuba-shi (JP); Mika KOBUNE, Tsukuba-shi (JP); Yuki Nakamura, Tsukuba-shi (JP); Tetsushi MARUYAMA, Hitachi-shi (JP)

(73) Assignee: Hitachi Chemical Company, Ltd., Tokyo (JP)

(21) Appl. No.: 15/025,343

(22) PCT Filed: Sep. 30, 2014
(86) PCT No.: PCT/JP2014/076149

§ 371 Date: Mar. 28, 2016

(30) Foreign Application Priority Data
Sep. 30, 2013 (JP) 2013-204117
Jan. 17, 2014 (JP) 2014-006575

(51) Int. Cl. C08L 97/00; C08L 61/06

(52) U.S. Cl. CPC C08L 97/005; C08L 61/06

(57) ABSTRACT

Disclosed is a resin composition containing lignin and a phenol resin, the lignin being one resulting from separation of a cellulose component and a hemicellulose component from a decomposition product obtained by subjecting a plant raw material to a decomposition treatment, and the lignin and the phenol resin being mixed in a solvent. It is possible to provide a resin composition capable of being melt kneaded at low temperatures and having excellent processability and moldability, a production method for the same, and a molded product using the same.

### TECHNICAL FIELD

The present invention relates to a resin composition, a molded product, and a production method.

### BACKGROUND ART

Hitherto, chemical products have been produced from fossil resources, such as petroleum, etc. In recent years, with the spread of a so-called carbon neutral concept, there is an increasing demand for biomass plastics. Then, there is a recent active tendency that consumer plastic products used for packing materials, parts of domestic appliances, automobile parts, and so on are replaced with plant-derived resins (bioplastics).

As raw materials of plant-derived heat-resistant resin materials, lignin is watched. The lignin is a polymer of a crosslinked structure having a hydroxyphenyl propane unit as a basic skeleton. Trees have an interpenetrating polymer network (IPN) structure constituted from a hydrophilic linear polymeric polysaccharide structure (cellulose and hemicellulose) and a hydrophobic crosslinked lignin structure. In view of the fact that the lignin occupies about 25% by mass of the trees and has a chemical structure of polyphenol, the lignin is expected as a substitute material of petroleum-derived phenol resins. Such lignin has such a characteristic feature that it has extremely excellent heat resistance as compared with other bioplastics represented by polylactic acid. Thus, the lignin is expected to be applied to uses, such as automobile parts, OA-relating parts, etc., for which the other bioplastics have been so far unable to be applied because of insufficient heat resistance.

Meanwhile, since the lignin has an alcoholic hydroxyl group and a phenolic hydroxyl group, it has high softening temperature and melting point as compared with general phenol resins. For example, PTL 1 describes that a melting point of rice-derived lignin is 174° C. (PTL 1, paragraph 0028). In addition, the fluidity of lignin alone in the vicinity of the softening temperature is low. For this reason, if the lignin is kneaded with other resin at low temperatures for the purpose of obtaining a molding material, there is a concern that the lignin is not thoroughly compatibilized, so that the resultant becomes heterogeneous. For this reason, in order to obtain a homogeneous molding material together with other resin, it was needed to knead at high temperatures. In addition, in the case of adding a curing agent, followed by kneading, there was encountered such a problem that curing occurs before the resins are thoroughly kneaded with each other.

In recent years, as means for dissolving such defects of lignin, so-called explosion lignin, which is obtained by the steam explosion method of exploding a plant raw material in the presence of steam, and a composition using the same are studied. For example, those described in PTLs 2 to 4 are known. But, the materials described in those patent literatures involved a problem on the compatibility of the resin composition, and so on and were not sufficiently satisfactory with processability, moldability, and the like.

Furthermore, as molding materials using lignin and a phenol resin, for example, those described in PTLs 5 to 7 are known. A technique of mixing lignin and the phenol resin described in these patent literatures is one which performs the mixing in a powder state, and it also involved a problem on the compatibility, and so on and was not sufficiently satisfactory with processability, moldability, and the like.

In addition, with respect to the use of lignin as an additive to rubber, for example, as disclosed in PTL 8, the use as a filler for pneumatic tire is known. However, the lignin is not used as a substitute material of a phenol resin to be used as a rubber reinforcing agent but is limited only to the use as a filler represented by carbon black. It is the present situation that there has not been realized yet the use method of sufficiently making the best use of properties that the lignin has.

### CITATION LIST

### Patent Literature

PTL 1: JP 2012-236811A

PTL 2: JP 2009-263549A

PTL 3: WO 2011/099544A

PTL 4: JP 2012-092282A

PTL 5: JP 2002-277615A

PTL 6: JP 2009-167306A

PTL 7: JP 2013-116995A

PTL 8: JP 2011-522085A

### SUMMARY OF INVENTION

### Technical Problem

Then, an object of the present invention is to provide a resin composition which contains plant-derived lignin as a raw material from the viewpoint of reducing environmental burdens, is capable of being melt kneaded at low temperatures and has excellent processability and moldability, a production method for the same and a molded product using the same.

### Solution to Problem

The present invention provides the following [1] to [14].

[1] A resin composition containing lignin and a phenol resin, the lignin being one resulting from separation of a cellulose component and a hemicellulose component from a decomposition product obtained by subjecting a plant raw material to a decomposition treatment, and the lignin and the phenol resin being mixed in a solvent.
[2] The resin composition as set forth above in [1], wherein the solvent is at least one selected from the group consisting of an alcohol, a phenol, a ketone, and an ether, or a water-containing organic solvent having water added thereto.
[3] The resin composition as set forth above in [1] or [2], wherein the lignin has a weight average molecular weight of 100 to 7,000.
[4] The resin composition as set forth above in any one of [1] to [3], wherein the lignin is contained in an amount of 5 to 95% by mass relative to a sum total of the lignin and the phenol resin.
[5] The resin composition as set forth above in any one of [1] to [4], further containing a curing agent.
[6] The resin composition as set forth above in [5], wherein the curing agent is an aldehyde compound or a compound capable of producing formaldehyde.
[7] The resin composition as set forth above in any one of [1] to [6], further containing a curing accelerator.
[8] The resin composition as set forth above in [7], wherein the curing accelerator contains calcium hydroxide or an organic acid having an aromatic ring or an alicyclic ring.
[9] The resin composition as set forth above in [8], wherein the curing accelerator contains an organic carboxylic acid having an aromatic ring or an alicyclic ring.
[10] The resin composition as set forth above in [9], wherein the organic carboxylic acid having an aromatic ring or an alicyclic ring is benzoic acid or salicylic acid.
[11] The resin composition as set forth above in any one of [1] to [10], further containing a rubber.
[12] The resin composition as set forth above in any one of [1] to [11], wherein the method of the decomposition treatment is a method using water.
[13] A molded product formed using the resin composition as set forth above in any one of [1] to [12].
[14] A production method of a resin composition for producing the resin composition as set forth above in any one of [1] to [12], including a step of decomposing a plant raw material containing lignin, a step of extracting lignin with an organic solvent or a water-containing organic solvent from a decomposition product obtained by the decomposition step, and a step of dissolving the lignin and the phenol resin in an organic solvent or a water-containing organic solvent and then removing the solvent.

### Advantageous Effects of Invention

According to the present invention, it is possible to provide a resin composition from which effects for reducing both an amount of fossil resources used and an amount of carbon dioxide discharged are attained, which is therefore suitable for reducing environmental burdens, and which is further excellent in processability and moldability.

### DESCRIPTION OF EMBODIMENTS

The present invention is hereunder described in more detail.

The resin composition of the present invention contains plant raw material-derived lignin as a main raw material. The lignin has a phenolic hydroxyl group and an alcoholic hydroxyl group, and by using a curing agent and thereby forming a three-dimensional crosslinked structure thereof, it is possible to obtain a resin material and a molded product each having a high glass transition temperature.

A weight average molecular weight (Mw) of the lignin is preferably 100 to 7,000, more preferably 100 to 5,000, and still more preferably 100 to 4,000 in terms of a value as reduced into standard polystyrene. When the weight average molecular weight of the lignin is 100 to 7,000, it is possible make the best use of the structure of lignin while keeping the solubility of lignin.

A molecular weight distribution (Mw/Mn) of the lignin is preferably 1.0 to 5.5, more preferably 1.0 to 4.5, and still more preferably 1.0 to 4.0.

It is to be noted that the weight average molecular weight and the molecular weight distribution are measured by means of gel permeation chromatography (GPC), and values as reduced into standard polystyrene may be used. A calibration curve may be approximated according to a cubic formula by using a 12-samples set of standard polystyrene (PS-Oligomer Kit (a trade name, available from Tosoh Corporation).

Preferred conditions of the GPC measurement in the present invention are shown below.

Apparatus: (Pump: DP-8020 Model, available from Tosoh Corporation), (detector: RI-8020 Model, available from Tosoh Corporation)

Column: Gelpack GL-A1205+Gelpack GL-A1405 (two columns in total) (trade name, available from Hitachi High-Technologies Corporation)

Column size: 10.7 mm I.D.×300 mm, eluent: tetrahydrofuran, sample concentration: 10 mg/1 mL, injection amount: 200 μL, flow rate: 1.0 mL/min, measurement temperature: 25° C.

As for the lignin which is used in the present invention, it is preferred that its sulfur content is small. This is because if the content of a sulfur atom increases, a hydrophilic sulfonic group increases, so that the solubility in the organic solvent is lowered. More specifically, the content of the sulfur atom in the lignin is preferably 2% by mass or less, more preferably 1% by mass or less, and still more preferably 0.5% by mass or less.

The lignin in the resin composition of the present invention is contained in an amount of preferably 5 to 95% by mass, more preferably 30 to 95% by mass, and still more preferably 60 to 95% by mass relative to a sum total of the lignin and the phenol resin in the resin composition. When the content of the lignin is 95% by mass or less, the effect for lowering the melting temperature is thoroughly obtained, and there is a tendency that the resin composition is excellent in moldability and processability. On the other hand, when the content of the lignin is 5% by mass or more, the effects for reducing fossil resources and CO₂ may be increased.

The lignin which is used in the present invention is one obtained from plants and resulting from separation of a cellulose component and a hemicellulose component from a decomposition product obtained by subjecting a plant raw material to a decomposition treatment. The lignin is more preferably one substantially composed of lignin, from which the cellulose component and the hemicellulose component have been removed.

As a method of separating and extracting the lignin from the plant raw material, there is generally adopted a method of decomposing the plant raw material through a treatment in the presence of a solvent, in the presence of a catalyst, and/or under high-temperature and high-pressure conditions. Specifically, the plant raw material is adjusted to a fixed size and charged together with a solvent and optionally a catalyst in a pressure container equipped with a stirrer and a heating device, and the contents are stirred while heating and applying a pressure to undergo a decomposition treatment of the plant raw material. Subsequently, the contents of the pressure container are filtered to remove the filtrate, and a water-insoluble matter is washed with water and then separated. Subsequently, the aforementioned water-insoluble matter is dipped in a solvent in which a lignin compound is soluble to extract the lignin compound, and the solvent is distilled off, whereby the lignin may be obtained.

The size of the plant raw material is preferably about 100 μm to 1 cm, and more preferably 200 μm to 500 μm. A shape of the plant raw material is not particularly limited, and it may be any of a block shape, a chip shape, a powder shape, and the like.

As a specific method of separating and extracting the lignin from the plant raw material, there are exemplified a kraft method, a sulfate method, a digesting method, a steam explosion method, and the like. Most of lignins being presently produced in a large amount are available in the form of residues produced upon production of cellulose as a raw material of papers or bio-ethanol.

The kraft method is a method in which a wood is digested with a mixed liquid of sodium hydroxide and sodium sulfide at preferably 160 to 170° C. for preferably 5 to 12 hours, and the lignin in the wood is eluted as an alkali thiolignin into a waste liquid. The sulfate method is a method in which a wood chip is digested with a mixed liquid of an acidic sulfite and sulfurous acid at preferably 130 to 145° C. and at preferably 6 to 8 kg/cm² for preferably 10 to 12 hours, and the lignin in the wood is eluted as a lignin sulfonate into a waste liquid. The digesting method is a method in which a wood chip is digested in an autoclave or the like with a steam at preferably 150 to 200° C. for preferably 10 to 20 minutes, followed by pulverization by a pulverizer, such as a refiner, etc. It is to be noted that the steam explosion method is described later in detail.

In the present invention, a method of separating the cellulose component and the hemicellulose component from the plant raw material by a method using water is a suitable technique. That is, the aforementioned method is a method of separating lignin from the cellulose component and the hemicellulose component by means of hydrolysis using water. In accordance with this method, lignin not containing a sulfur atom in the lignin, or lignin with a small content of a sulfur atom, is obtained. As a specific separation method, there is exemplified a separation method using a steam (steam explosion method).

The steam explosion method is a production method in which the plant raw material is treated with only a steam, thereby separating lignin from the cellulose component and the hemicellulose component, followed by dissolution in an organic solvent. If a chemical other than water is used, there may be the case where the lignin is denatured, so that there is a tendency that a lowering in solubility in the organic solvent is generated, or the plant raw material becomes difficult to be thermally melted, and hence, for example, there is a concern that the workability of the composition is lowered, so that the composition cannot be coated on an aggregate. Therefore, as the technique of separating the lignin from the cellulose component and the hemicellulose component, the digesting method or the steam explosion method using only water is a suitable technique. It is to be noted that in general, the steam explosion method is a method which performs pulverizing for a short period of time due to hydrolysis with a high-temperature and high-pressure steam and a physical pulverization effect by instantaneously releasing the pressure.

The apparatus to be used for the steam explosion method may be either a batch type or a continuous type. Though the conditions of the steam explosion method are not particularly limited, it is preferred that the raw material is charged in a pressure container for steam explosion apparatus, a steam at 0.5 to 4.0 MPa is introduced under pressure thereinto, a heat treatment is conducted for 1 to 60 minutes, and the pressure is then instantaneously released, thereby obtaining an explosion treatment product. Furthermore, under conditions of 2.1 to 4.0 MPa, the heat treatment is conducted for preferably 1 to 30 minutes, and more preferably 1 to 10 minutes. Under conditions of 0.5 to 2.0 MPa, the heat treatment is conducted for preferably 5 to 40 minutes, and more preferably 10 to 30 minutes. When the heat treatment time is 1 minute or more, the lignin may be thoroughly separated from the cellulose component and the hemicellulose component, and there is a tendency that a yield of the lignin is improved. When the heat treatment time is 60 minutes or less, the matter that the once separated lignin is condensed to have a higher molecular weight, whereby it becomes hardly soluble in the organic solvent may be reduced, and there is a tendency that a yield of the lignin is improved.

The plant raw material in the present invention is not particularly limited so long as the lignin may be extracted therefrom. Examples of the plant raw material include Japanese cedar, bamboo, rice straw, wheat straw, Japanese cypress, acacia, willow, poplar, corn, sugar cane, rice hulls, eucalyptus, coconut shell, and the like.

The lignin is extracted from a decomposition product obtained by subjecting the plant raw material to a decomposition treatment by means of a method, such as a steam explosion method, etc. As the organic solvent to be used on that occasion, an alcohol solvent composed of a single alcohol, a mixed alcohol having plural alcohols mixed with each other, a water-containing alcohol solvent of an alcohol having water mixed therewith, other organic solvent, a water-containing organic solvent of the foregoing organic solvent having water mixed therewith, and the like may be exemplified. As the water, ion-exchanged water is preferably used. In the case of a mixed solvent with water, the water content is preferably more than 0 and 70% by mass or less. Since the solubility of the lignin in water is low, if a solvent having a water content of more than the foregoing range is used, there is a tendency that it becomes difficult to extract the lignin. By choosing the solvent to be used, it becomes possible to control the weight average molecular weight of the resulting lignin.

Examples of the alcohol include monool-based alcohols, such as methanol, ethanol, n-propanol, isopropanol, n-butanol, tert-butanol, n-hexanol, benzyl alcohol, cyclohexanol, etc.; and polyol-based alcohols, such as ethylene glycol, diethylene glycol, 1,4-butanediol, 1,6-hexanediol, trimethylol propane, glycerin, triethanolamine, etc. Also, from the viewpoint of reducing environmental burdens, the alcohol is preferably an alcohol obtained from a natural substance. Specific examples of the alcohol obtained from a natural substance include methanol, ethanol, n-propanol, isopropanol, n-butanol, tert-butanol, 1,3-propanediol, 1,3-butanediol, 1,4-butanediol, ethylene glycol, glycerin, hydroxymethyl furfural, and the like.

The phenol resin which is used in the present invention is not particularly limited, and examples thereof include novolak-type phenol resins, resole-type phenol resins, modified novolak-type phenol resins, and modified resole-type phenol resins. These phenol resins may be contained solely or in combination of two or more thereof. Of those, novolak-type phenol resins are preferred from the standpoint that the solubility in the solvent may be ensured.

A softening point of the phenol resin is preferably lower. More specifically, it is preferred to use a phenol resin having a softening point of 100° C. or lower from the standpoint that the solubility in the solvent may be ensured.

Examples of commercially available phenol novolak resins having a softening point of 100° C. or lower include HP-850N (available from Hitachi Chemical Company, Ltd., softening point: 83° C.), TD-2131 (available from DIC Corporation, softening point: 78 to 82° C.), TD-2161 (available from DIC Corporation, softening point: 88 to 95° C.), and the like.

The softening point of the aforementioned phenol novolak resin may be measured by means of the ring and ball method with a glycerin bath as described in JIS K7234.

In the present invention, other resin than the lignin and the phenol resin may be used in combination within the range where the effects of the present invention are not impaired. Examples of the other resin include polyolefins, such as polyethylene, polypropylene, etc., polyesters, such as polyethylene terephthalate, polybutylene terephthalate, etc., polystyrene, polyvinyl alcohol, polyphenylene ether, polyetheretherketone, polyacetal, acrylic resins, such as polymethyl methacrylate, etc., polylactic acid, furan resins, epoxy resins, urethane resins, urea resins, melamine resins, and the like. These resins may be contained solely or in combination of two or more thereof.

It is preferred that the resin composition of the present invention further contains a curing agent. Examples of the curing agent (crosslinking agent) which is used in the present invention include an aldehyde compound, a compound capable of producing formaldehyde, and the like.

The aldehyde compound is not particularly limited, and examples thereof include formaldehyde, paraformaldehyde, trioxane, acetaldehyde, propionaldehyde, chloral, furfural, glyoxal, n-butyraldehyde, caproaldehyde, allyl aldehyde, benzaldehyde, crotonaldehyde, acrolein, phenyl acetaldehyde, o-tolualdehyde, salicylaldehyde, and the like.

Examples of the compound capable of producing formaldehyde include hexamethylenetetramine and the like. Of those, the compound capable of producing formaldehyde is preferred.

These curing agents may be used solely or in combination of two or more thereof. Above of all, hexamethylenetetramine is preferred from the standpoints of curability, heat resistance, and the like.

A content of the curing agent is preferably 1 to 40 parts by mass based on 100 parts by mass of a sum total of the lignin and the phenol resin in the resin composition from the standpoints of heat resistance and strength. The content of the curing agent is more preferably 10 to 30 parts by mass.

In the resin composition of the present invention, it is preferred to further use a curing accelerator. The curing accelerator which may be used is not particularly limited, and examples thereof include cycloamidine compounds, quinone compounds, tertiary amines, organic phosphines, imidazoles, such as 1-cyanoethyl-2-phenyl imidazole, 2-methyl imidazole, 2-phenyl imidazole, 2-phenyl-4-methyl imidazole, 2-heptadecyl imidazole, etc., calcium hydroxide (e.g., slaked lime, etc.), organic acids having an aromatic ring or an alicyclic ring, and the like. Of those, in view of the fact that a high-strength molded product capable of being subjected to low-temperature curing is obtained, calcium hydroxide (e.g., slaked lime, etc.) and an organic acid having an aromatic ring or an alicyclic ring are preferred, an organic acid having an aromatic ring or an alicyclic ring is more preferred, and an organic carboxylic acid having an aromatic ring or an alicyclic ring is especially preferred.

Examples of the organic acid having an aromatic ring or an alicyclic ring include aromatic monocarboxylic acids, such as benzoic acid, salicylic acid, (o-, m-, or p-)toluic acid, (o-, m-, or p-)cresotinic acid, gallic acid, 1-naphthenic acid, 2-naphthenic acid, etc.; aromatic polybasic carboxylic acids, such as phthalic acid, isophthalic acid, terephthalic acid, trimellitic acid, pyromellitic acid, mellitic acid, etc.; alicyclic mono- or polybasic carboxylic acids, such as cyclohexanecarboxylic acid, 5-norbornene-2-carboxylic acid, 1,2-cyclohexanedicarboxylic acid, 1,4-cyclohexanedicarboxylic acid, etc., and the like. Of those, aromatic monocarboxylic acids are preferred, salicylic acid and benzoic acid are especially preferred, and benzoic acid is extremely preferred.

From the standpoint of moldability, the curing accelerator is used in an amount of preferably 1 to 30 parts by mass, more preferably 5 to 25 parts by mass, and especially preferably 10 to 25 parts by mass based on 100 parts by mass of a sum total of the lignin and the phenol resin in the resin composition.

Furthermore, the resin composition and the molded product of the present invention may contain a natural filler or a chemical filler.

The natural filler includes plant-based, animal-based, and mineral-based fillers. Examples of the plant-based filler include fibers, pulverized powders, or the like of cotton, bamboo, ramie, flax (linen), Manila hemp (abaca), sisal hemp, jute, kenaf, banana, coconut, straw, sugar cane, Japanese cedar, Japanese cypress, Hondo spruce, pine tree, Japanese fir, and Japanese larch.

Examples of the animal-based filler include animal hair fibers, silk fibers, and the like, and examples of the mineral-based filler include asbestos and the like. These may be added as a powdered material, such as a paper powder, a chitin powder, a chitosan powder, a protein, a starch, etc.

The plant-based filler is preferably a wood-based filler. Since the wood-based filler is inexpensive and good in processability, it is especially preferred among the natural fillers. As the wood-based filler, one prepared by taking out in a fiber form, or one prepared by pulverization into a powder form may be used.

The chemical filler includes an inorganic filler, a synthetic filler, and the like. Examples of the inorganic filler include carbon-based fillers of carbon fibers, carbon black, active carbon, graphite, etc.; metal-based fillers of iron, copper, nickel, aluminum, etc.; oxide-based fillers of silica, alumina, titanium oxide, iron oxide, zinc oxide, magnesium oxide, tin oxide, antimony oxide, barium ferrite, strontium ferrite, etc.; hydroxide-based fillers of aluminum hydroxide, magnesium hydroxide, etc.; carbonate-based fillers of calcium carbonate, magnesium carbonate, etc.; sulfate-based fillers of calcium sulfate, etc.; silicate-based fillers of talc, clay, mica, calcium silicate, glass, glass hollow spheres, glass fibers, etc.; and others, such as calcium titanate, lead zirconate titanate, aluminum nitride, silicon carbide, cadmium sulfide, etc.

Examples of the synthetic filler include polyester-based, polyamide-based, acrylic, urethane-based, polyvinyl chloride-based, polyvinylidene chloride-based, acetate-based, aramid-based, nylon-based, and vinylon-based fillers, and the like.

The resin composition of the present invention is obtained by dissolving the lignin and the phenol resin in a solvent (generally an organic solvent), mixing them in the solvent, and then removing the solvent. If the lignin and the phenol resin are mixed without being dissolved in a solvent, since they are not thoroughly compatibilized with each other, the softening temperature and the melting point of the resin composition are not thoroughly decreased, so that it is difficult to undergo melt kneading at low temperatures.

In the present invention, the organic solvent capable of dissolving the lignin and the phenol resin therein is preferably at least one organic solvent selected from the group consisting of an alcohol, a phenol, a ketone, and an ether, or a water-containing organic solvent having water added thereto. Of those, from the viewpoint of solubility of the lignin, a ketone is preferred, and acetone is especially preferred.

The resin composition of the present invention may be used as various coating materials. The coating material is suitable for uses for heat resistance, lamination immersion, metal coating, and the like.

The resin composition of the present invention may be used as various molded products. The molded product is suitable for uses for automobiles, OA instrument casings, building materials, and the like.

Furthermore, the resin composition of the present invention may also contain a rubber component. The rubber component is not particularly limited, and natural rubbers and synthetic rubbers may be used. Examples of the synthetic rubber include an isoprene rubber, a butadiene rubber, a styrene-butadiene rubber, a chloroprene rubber, a nitrile rubber, a butyl rubber, a halobutyl rubber, a crosslinked polyethylene rubber, an ethylene propylene rubber, an acrylic rubber, a fluorine rubber, and the like.

In the resin composition containing a rubber component of the present invention, the lignin is contained in an amount of preferably 0.1 to 50% by mass, more preferably 0.1 to 40% by mass, and still more preferably 0.5 to 30% by mass relative to a sum total of the lignin and the rubber component. When the amount of the lignin is 50% by mass or less, the effect for decreasing the melting temperature is thoroughly obtained, and there is a tendency that the resin composition is excellent in moldability and processability. On the other hand, when the amount of the lignin is 0.1% by mass or more, the effects for reducing fossil resources and CO₂ may be increased, and the mechanical strength of the rubber may also be improved.

It is to be noted that the resin composition containing a rubber component may further contain, in addition to the aforementioned natural filler or chemical filler or the like, a vulcanizer, a vulcanization accelerator, and the like which are used for known rubber compositions.

### EXAMPLES

The present invention is hereunder described by reference to Examples. It is to be noted that the present invention is not limited to these Examples.

### Example 1

### Extraction of Lignin

400 g (dry mass) of a bamboo chip was charged in a 2-L pressure container of a steam explosion apparatus, and a steam was introduced under pressure thereinto so as to provide a pressure of 3.5 MPa, followed by holding for 3 minutes. Thereafter, the valve was rapidly opened to obtain an explosion treatment product. The resulting explosion treatment product was washed with water, and a water-soluble component was removed until the pH of the washing water reached 6 or more. Thereafter, the residual moisture was removed at 105° C. A dry extraction solvent (acetone) in an amount of 3 times relative to this dry product in terms of a mass was added, followed by stirring for 10 minutes. Thereafter, a fibrous substance was removed by means of filtration. The acetone was removed from the resulting filtrate, thereby obtaining 60 g of lignin. The thus obtained lignin was a brown powder at an ordinary temperature (25° C.).

### (Weight Average Molecular Weight of Lignin)

A molecular weight of the lignin was measured by a gel permeation chromatograph (GPC) equipped with a differential refractometer. The measurement of the molecular weight was conducted with columns Gelpack GL-A1205 and Gelpack GL-A1705, each being available from Hitachi High-Technologies Corporation (“Gelpack” is a registered trademark), which were connected in series with each other, by using polystyrene with a small distribution as a standard sample and tetrahydrofuran as a moving phase. As a result, its weight average molecular weight was found to be 2,900.

### (Hydroxyl Group Quantity)

A hydroxyl group equivalent in the lignin was determined from a hydroxyl group value and an acid value. The hydroxyl group value was determined by means of the acetic anhydride-pyridine method, and the acid value was determined by means of the potential-difference titration method. As a result, the hydroxyl group equivalent of the resulting lignin was found to be 130 g/eq. Subsequently, a ratio of the phenolic hydroxyl group and the alcoholic hydroxyl group was analyzed by means of the ¹H-NMR measurement. The ¹H-NMR (proton nuclear magnetic resonance) was measured with deuterochloroform (CDCl₃) as a solvent at a frequency of 400 MHz by using a nuclear magnetic resonance spectrometer (a trade name: AMX400), available from Bruker Inc. As a result, the hydroxyl group in the lignin was found to be a ratio of the phenolic hydroxyl group to the alcoholic hydroxyl group of 1.5/1.

### (Preparation of Resin Mixture)

95 g of the aforementioned lignin and 5 g of a phenol resin (a trade name: HP-850N, available from Hitachi Chemical Company, Ltd., softening point: 83° C., measured by the aforementioned ring and ball method) were dissolved in 100 g of acetone (a special grade reagent, available from Wako Chemical Industries, Ltd.), the acetone was removed by an evaporator, and the resulting powder was vacuum dried at 50° C. for 2 hours, thereby obtaining a resin mixture having the lignin and the phenol resin mixed in the solvent (hereinafter referred to as “solvent/resin mixture”).

### (Softening Temperature and Melting Point)

A softening temperature and a melting point were measured by compression by means of thermomechanical analysis (TMA). Using a TMA apparatus (TMA-120 Model), available from SII Nano Technology Inc., the aforementioned solvent/resin mixture was filled in a thickness of 1 mm in an aluminum pan and measured in a nitrogen gas stream of 100 mL/min under conditions at a load of 49.1 mN in a measurement temperature range of from 25° C. to 250° C. at a temperature rise rate of 10° C./min. As a result, the solvent/resin mixture having the lignin and the phenol resin mixed in the solvent had a softening temperature of 87° C. and a melting point of 145° C.

### (Preparation of Molded Product)

100 g of the solvent/resin mixture of the lignin and the phenol resin as thus obtained above, 20 g of hexamethylenetetramine (available from Shandong Runyin Biochemical Co., Ltd.) as a curing agent, and 5 g of calcium hydroxide (available from Wako Chemical Industries, Ltd.) as a curing accelerator were mixed, to which were then added 4 g of zinc stearate as a release agent and 40 g of a wood powder (CELLULOSIN 100M (particle diameter: 150 μm), available from Kunimi Kosan Y.K.) as a filler, thereby preparing a resin composition, and the resulting resin composition was kneaded by a roll device at 100° C. until it became uniform. The resulting semi-cured product was pulverized by a pulverizer, and the pulverized product was compression molded at 180° C. for 2 minutes to obtain a molded product.

### (Flexural Strength and Flexural Modulus)

A flexural strength and a flexural modulus of the prepared molded product were evaluated using AUTOGRAPH AG-50kNXPlus (a trade name, available from Shimadzu Corporation; “AUTOGRAPH” is a registered trademark) by means of a three-point bending test. The test was conducted using a test piece having a size of 130 mm×13 mm×3 mm at a distance between supports of 48 mm and at a testing speed of 1 mm/min. As a result, the flexural strength was found to be 146 MPa and had no practical problem. In addition, the flexural modulus was found to be 4.2 GPa, and the reduction of elasticity could be achieved while keeping the strength as compared with Comparative Example 2 as described later.

### Example 2

A solvent/resin mixture was obtained in the same manner as in Example 1, except for using 75 g of the lignin and 25 g of the phenol resin. The softening temperature and the melting point of the solvent/resin mixture were measured in the manner as in Example 1. As a result, the resin mixture of the lignin and the phenol resin had a softening temperature of 76° C. and a melting point of 131° C.

A molded product was obtained in the same manner as in Example 1, except for using 100 g of the aforementioned solvent/resin mixture of the lignin and the phenol resin. The flexural strength and the flexural modulus of the molded product were measured in the same manner as in Example 1. As a result, the flexural strength was found to be 142 MPa, and the flexural modulus was found to be 4.1 GPa.

### Example 3

A solvent/resin mixture of lignin and a phenol resin was obtained in the same manner as in Example 1, except for using 50 g of the lignin and 50 g of the phenol resin.

The softening temperature and the melting point were measured in the same manner as in Example 1. As a result, the solvent/resin mixture of the lignin and the phenol resin had a softening temperature of 66° C. and a melting point of 105° C.

A molded product was obtained in the same manner as in Example 1, except for using 100 g of the aforementioned solvent/resin mixture of the lignin and the phenol resin. The flexural strength and the flexural modulus of the molded product were measured in the same manner as in Example 1. As a result, the flexural strength was found to be 137 MPa, and the flexural modulus was found to be 4.2 GPa.

### Comparative Example 1

With respect to the lignin obtained in Example 1, the softening temperature and the melting point were measured in the same manner as in Example 1. As a result, the softening temperature was found to be 112° C., and the melting point was found to be 167° C. A molded product was prepared in the same manner as in Example 1, except that in Example 1, only the lignin was used in place of the solvent/resin mixture of the lignin and the phenol resin. However, since on the occasion of kneading at 100° C., the lignin was not wound around the rolls, the molded product was prepared without conducting kneading. The flexural strength and the flexural modulus of the molded product were measured in the same manner as in Example 1. As a result, the flexural strength was found to be 42 MPa, and the flexural modulus was found to be 6.1 GPa.

### Comparative Example 2

A molded product was prepared in the same manner as in Example 1, except that in Example 1, a mixture of 75 g of a lignin powder and 25 g of a phenol resin powder (hereinafter referred to as “dry mixture”) was used in place of the solvent/resin mixture of the lignin and the phenol resin. As a method of dry mixing, the roll kneading method was adopted (described as “Roll kneading” in the tables). However, immediately after winding around the rolls, the resin became hard, and the winding properties around the rolls were deteriorated, so that kneading could not be thoroughly conducted. For that reason, when the winding properties were deteriorated, the kneading was finished to prepare a molded product. The flexural strength and the flexural modulus of the molded product were measured in the same manner as in Example 1. As a result, the flexural strength was found to be 89 MPa, and the flexural modulus was found to be 4.8 GPa.

### Comparative Example 3

A molded product was prepared in the same manner as in Example 1, except that in Example 1, a dry mixture of 50 g of a lignin powder and 50 g of a phenol resin powder was used in place of the solvent/resin mixture of the lignin and the phenol resin. As a method of dry mixing, the roll kneading method was adopted in the same manner as in Comparative Example 2. However, immediately after winding around the rolls, the resin became hard, and the winding properties around the rolls were deteriorated, so that kneading could not be thoroughly conducted. For that reason, when the winding properties were deteriorated, the kneading was finished to prepare a molded product. The flexural strength and the flexural modulus of the molded product were measured in the same manner as in Example 1. As a result, the flexural strength was found to be 102 MPa, and the flexural modulus was found to be 4.3 GPa.

### Examples 4 to 6

Molded products were prepared in the same manner as in Example 3, except that in Example 3, in place of mixing 5 g of calcium hydroxide used as the curing accelerator at the time of preparation of a molded product, 20 g of salicylic acid was used in Example 4, 20 g of benzoic acid was used in Example 5, and 20 g of calcium hydroxide was used in Example 6, and that the molding temperature was changed from 180° C. to 145° C. in Example 4 and 150° C. in Examples 5 and 6, respectively. The results obtained by measuring the flexural strength and the flexural modulus of the molded products in the same manner as in Example 1 are shown in Table 1. It is to be noted that the results of Examples 1 to 3 and Comparative Examples 1 to 3 are also shown in Table 1.

TABLE 1

| | | Softening | Melting | Flexural | Flexural |
|---|---|---|---|---|---|
| | | temperature | point | strength | modulus |
| Item | | (° C.) | (° C.) | (MPa) | (GPa) |
| Example 1 | Lignin/phenol = 95/5 | 87 | 145 | 146 | 4.2 |
| | (Mixing in solvent) | | | | |
| Example 2 | Lignin/phenol = 75/25 | 76 | 131 | 142 | 4.1 |
| | (Mixing in solvent) | | | | |
| Example 3 | Lignin/phenol = 50/50 | 66 | 105 | 137 | 4.2 |
| | (Mixing in solvent) | | | | |
| Example 4 | Lignin/phenol = 50/50 | 62 | 100 | 145 | 4.5 |
| | (Mixing in solvent) | | | | |
| Example 5 | Lignin/phenol = 50/50 | 61 | 100 | 150 | 4.5 |
| | (Mixing in solvent) | | | | |
| Example 6 | Lignin/phenol = 50/50 | 68 | 105 | 150 | 4.3 |
| | (Mixing in solvent) | | | | |
| Comparative | Lignin/phenol = 100/0 | 112 | 167 | 42 | 6.1 |
| Example 1 | | | | | |
| Comparative | Lignin/phenol = 75/25 | — | — | 89 | 4.8 |
| Example 2 | (Roll kneading) | | | | |
| Comparative | Lignin/phenol = 50/50 | — | — | 102 | 4.3 |
| Example 3 | (Roll kneading) | | | | |

### Example 7

### Preparation of Resin Composition Containing Rubber Component

25 g of the solvent/resin mixture of the lignin and the phenol resin obtained in Example 2 and 5 g of hexamethylenetetramine (available from Shandong Runyin Biochemical Co., Ltd.) were thoroughly mixed in advance in a mortar, with which were then compounded 250 g of a natural rubber, 10 g of sulfur, 5 g of zinc oxide, and 10 g of zinc stearate; the contents were kneaded at 110° C. by using, as a kneading device, Plasti-Corder Lab-Station (Mixer 350E, 370 mL, available from Brabender GmbH & Co.) until they were uniformly dispersed; and the resultant was molded at 150° C. for 15 minutes by using, as a press machine, Laboplastomill (a press machine, available from Toho Press Seisakusho Y.K.; a manual type 26-ton hydraulic press; T-die sheet preparation by a short-screw extruder), thereby obtaining a sheet-like resin composition having a thickness of 2 mm.

### (Tensile Strength and Tensile Elongation)

A tensile strength and a tensile elongation of the resin composition were evaluated in conformity with JIS K6251. Each of the tests was conducted three times at a test speed of 500 mm/min by using a No. 3 type specimen as a dumbbell specimen, and an average value thereof was expressed. As a result, the tensile strength was found to be 21.8 MPa, and the tensile elongation was found to be 550%.

### Example 8

### Preparation of Solvent/Resin Mixture

75 g of the lignin as extracted in Example 1, 25 g of a phenol resin (a trade name: HP-850N, available from Hitachi Chemical Company, Ltd.), and 20 g of benzoic acid were dissolved in 100 g of acetone (a special grade reagent, available from Wako Chemical Industries, Ltd.), and the acetone was removed by an evaporator, and the resulting powder was vacuum dried at 50° C. for 2 hours, thereby obtaining a solvent/resin mixture of the lignin, the phenol resin, and the benzoic acid.

### (Preparation of Resin Composition Containing Rubber Component)

A resin composition containing a rubber component was obtained in the same manner as in Example 7, except for using 30 g of the aforementioned solvent/resin mixture of the lignin, the phenol resin, and the benzoic acid.

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 26.4 MPa, and the tensile elongation was found to be 650%.

### Example 9

75 g of the lignin as extracted in Example 1 and 25 g of a phenol resin (a trade name: HP-850N, available from Hitachi Chemical Company, Ltd.) were dissolved in 100 g of acetone (a special grade reagent, available from Wako Chemical Industries, Ltd.); the acetone was removed by an evaporator; the resulting powder was vacuum dried at 50° C. for 2 hours; and the resultant was thoroughly mixed with 20 g of calcium hydroxide in a mortar, thereby obtaining a solvent/resin mixture of the lignin, the phenol resin, and the calcium hydroxide.

### (Preparation of Resin Composition Containing Rubber Component)

A resin composition containing a rubber component was obtained in the same manner as in Example 7, except for using 30 g of the aforementioned solvent/resin mixture of the lignin, the phenol resin, and the calcium hydroxide.

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 23.7 MPa, and the tensile elongation was found to be 600%.

### Example 10

### Preparation of Resin Composition Containing Rubber Component

A sheet-like resin composition was prepared in the same manner as in Example 7, except for using 25 g of the solvent/resin mixture of the lignin and the phenol resin as obtained in Example 3, and the tensile strength and the tensile elongation were measured in the same manner as in Example 7. As a result, the tensile strength was found to be 22.1 MPa, and the tensile elongation was found to be 580%.

### Example 11

A solvent/resin mixture of the lignin, the phenol resin, and the benzoic acid and a resin composition containing a rubber component were obtained in the same manner as in Example 8, except that in Example 8, 50 g of the lignin and 50 g of the phenol resin were used.

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 25.0 MPa, and the tensile elongation was found to be 590%.

### Example 12

A solvent/resin mixture of the lignin, the phenol resin, and the calcium hydroxide and a resin composition containing a rubber component were obtained in the same manner as in Example 9, except that in Example 9, 50 g of the lignin and 50 g of the phenol resin were used.

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 24.7 MPa, and the tensile elongation was found to be 610%.

### Comparative Example 4

### Preparation of Resin Composition Containing Rubber Component

A resin composition containing a rubber component was prepared in the same manner as in Example 7, except that in Example 7, 25 g of the solvent/resin mixture of the lignin and the phenol resin was changed to 25 g of the lignin as extracted in Example 1.

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 16.3 MPa, and the tensile elongation was found to be 420%.

### Comparative Example 5

A resin composition containing a rubber component was prepared in the same manner as in Example 7, except that in Example 7, 25 g of the solvent/resin mixture of the lignin and the phenol resin was changed to 25 g of a dry mixture having a lignin powder and a phenol resin powder mixed with each other in a ratio of 75/25 (mass ratio).

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 19.4 MPa, and the tensile elongation was found to be 530%.

### Comparative Example 6

A resin composition containing a rubber component was prepared in the same manner as in Example 7, except that in Example 7, 25 g of the solvent/resin mixture of the lignin and the phenol resin was changed to 25 g of a dry mixture having a lignin powder and a phenol resin powder mixed with each other in a ratio of 75/25 (mass ratio).

### (Tensile Strength and Tensile Elongation)

A sheet-like resin composition was prepared in the same manner as in Example 7, and the tensile strength and the tensile elongation were measured in the same manner as in Example 7. As a result, the tensile strength was found to be 20.9 MPa, and the tensile elongation was found to be 570%.

The evaluation results of Examples 7 to 12 and Comparative Examples 4 to 6 are summarized in Table 2.

TABLE 2

| | | Softening | Melting | Tensile | Tensile |
|---|---|---|---|---|---|
| | | temperature | point | strength | elongation |
| Item | | (° C.) | (° C.) | (MPa) | (%) |
| Example 7 | Lignin/phenol = 75/25 | 76 | 131 | 21.8 | 550 |
| | (Mixing in solvent) | | | | |
| Example 8 | Lignin/phenol = 75/25 | 76 | 131 | 26.4 | 650 |
| | (Mixing in solvent) | | | | |
| Example 9 | Lignin/phenol = 75/25 | 76 | 131 | 23.7 | 600 |
| | (Mixing in solvent) | | | | |
| Example 10 | Lignin/phenol = 50/50 | 66 | 105 | 22.1 | 580 |
| | (Mixing in solvent) | | | | |
| Example 11 | Lignin/phenol = 50/50 | 66 | 105 | 25.0 | 590 |
| | (Mixing in solvent) | | | | |
| Example 12 | Lignin/phenol = 50/50 | 66 | 105 | 24.7 | 610 |
| | (Mixing in solvent) | | | | |
| Comparative | Lignin/phenol = 100/0 | 112 | 167 | 16.3 | 420 |
| Example 4 | | | | | |
| Comparative | Lignin/phenol = 75/25 | — | — | 19.4 | 530 |
| Example 5 | (Roll mixing) | | | | |
| Comparative | Lignin/phenol = 50/50 | — | — | 20.9 | 570 |
| Example 6 | (Roll mixing) | | | | |

In the light of the above, the resin composition according to the present invention contains plant-derived lignin as a raw material, is capable of being melt kneaded at low temperatures, and has excellent processability and moldability, and its molded product is excellent in flexural strength and flexural modulus. Furthermore, the resin composition according to the present invention is also excellent in adjusting properties and applicability as a coating agent.

In addition, by using a curing accelerator, it is further possible to achieve low-temperature curing, and it is possible to further improve the flexural strength and the flexural modulus. In a rubber composition, it is possible to further improve its tensile strength.

1. A resin composition comprising lignin and a phenol resin, the lignin being one resulting from separation of a cellulose component and a hemicellulose component from a decomposition product obtained by subjecting a plant raw material to a decomposition treatment, and the lignin and the phenol resin being mixed in a solvent.

2. The resin composition according to claim 1, wherein the solvent is at least one organic solvent selected from the group consisting of an alcohol, a phenol, a ketone, and an ether, or a water-containing organic solvent having water added to the organic solvent.

3. The resin composition according to claim 1, wherein the lignin has a weight average molecular weight of 100 to 7,000.

4. The resin composition according to claim 1, wherein the lignin is contained in an amount of 5 to 95% by mass relative to a sum total of the lignin and the phenol resin.

5. The resin composition according to claim 1, further comprising a curing agent.

6. The resin composition according to claim 5, wherein the curing agent is an aldehyde compound or a compound capable of producing formaldehyde.

7. The resin composition according to claim 1, further comprising a curing accelerator.

8. The resin composition according to claim 7, wherein the curing accelerator contains calcium hydroxide or an organic acid having an aromatic ring or an alicyclic ring.

9. The resin composition according to claim 8, wherein the curing accelerator contains an organic carboxylic acid having an aromatic ring or an alicyclic ring.

10. The resin composition according to claim 9, wherein the organic carboxylic acid having an aromatic ring or an alicyclic ring is benzoic acid or salicylic acid.

11. The resin composition according to claim 1, further comprising a rubber component.

12. The resin composition according to claim 1, wherein the method of the decomposition treatment is a method using water.

13. A molded product formed using the resin composition according to claim 1.

14. A production method of a resin composition for producing the resin composition according to claim 1, comprising a step of decomposing a plant raw material containing lignin, a step of extracting lignin with an organic solvent or a water-containing organic solvent from a decomposition product obtained by the decomposition step, and a step of dissolving the lignin and a phenol resin in an organic solvent or a water-containing organic solvent and then removing the solvent.
